(19) United States
(12) Patent Application Publication
(10) Pub. No.: US 2016/0110021 A1
(43) Pub. Date: Apr. 21, 2016

(54) Testing Stylus

(71) Applicant: Anthrotronix, Inc., Silver Spring, MD (US)

(72) Inventors: Jack M. Vice, Orlando, FL (US); Corinna E. Lathan, Silver Spring, MD (US); James F. Drane, Washington, DC (US); Joli K. Rightmyer, Arlington, VA (US)

(73) Assignee: ANTHROTRONIX, INC., Silver Spring, MD (US)

(21) Appl. No.: 14/883,816

(22) Filed: Oct. 15, 2015

Related U.S. Application Data
(60) Provisional application No. 62/064,705, filed on Oct. 16, 2014.

(51) Int. Cl. G06F 3/041; G06F 3/044

(52) U.S. Cl. CPC G06F 3/0418; G06F 3/044

(57) ABSTRACT

Embodiments of the invention relate to a calibration device for interaction with a cognitive assessment device, employing the calibration device as a quality control device for interaction with the assessment device, and the calibration device in combination with the assessment device for every assessment. The calibration device includes at least two sensors for measurement of light and pressure. As the calibration device interfaces with the assessment device, or an alternative secondary device, both light intensity and capacitance are applied to test reaction time. Latencies associated with reaction time testing are detected, and thereafter are applied to assessment output.

### CROSS REFERENCE TO RELATED APPLICATION(S)

This application is a non-provisional patent application claiming the benefit of the filing date of U.S. Provisional Patent Application Ser. No. 62/064,705, filed Oct. 16, 2014, and titled “Testing Stylus” which is hereby incorporated by reference.

### BACKGROUND

The present invention relates to reaction time testing with respect to an assessment device. More specifically, the invention relates to detecting hardware and software latencies and variability in associated detected latencies of a reaction time testing device.

Latency is the amount of time a message takes to traverse a system. In a computer network, latency is an expression of how much time it takes for a packet of data to get from one designated point to another. It is sometimes measured as the time required for a packet to be returned to its sender.

Assessment devices are often used to test cognitive function by measuring reaction time as in the time it takes to response to a given stimuli. Latency is a critical component of cognitive assessment. More specifically, time is a factor that is employed in cognitive assessment to determine if there is an impairment. It is important to assess if the latency is hardware or software related, or if an associated time measurement is for the subject of the cognitive assessment. The variability of the latency is a function of the changes in latencies over time for a given assessment device. High latency variability can render an assessment device unusable for cognitive assessment.

### SUMMARY

The invention includes a method, computer program product, and system for detecting latency with respect to cognitive assessment and accommodating the detected latency with respect to the assessment.

In one aspect, reaction time is tested between a calibration device and an assessment device. The testing includes configuring the assessment device with stimuli, and configuring the calibration device to measure stimuli. A reaction time is calculated as a difference between stimuli presentation on a visual display and receipt of a response to the stimuli. Calibration device recorded reaction time is calculated as a difference between the time of the stimuli presentation and the time of receipt of the response to the stimuli by embedded hardware of the assessment device. A latency evaluation of the assessment device is returned as a difference between the calibration device recorded reaction time and the assessment device reaction time. The returned latency evaluation is applied, with the application including modifying assessment data with the latency evaluation.

In another aspect, a system is configured with a calibration device and an assessment device. The assessment device is configured to display stimuli, and the calibration device is configured to measure the displayed stimuli. The assessment device calculates user reaction time as a difference between presentation of the display stimuli and receipt of a response to the displayed stimuli. The calibration device calculates recorded reaction time as a difference between the time of stimuli display and time receipt of the response to the display stimuli by embedded hardware of the assessment device. A reaction time assessment takes place between the calibration device and the assessment device, with the assessment returning a latency evaluation of the assessment device as a difference between the calibration device recorded reaction time and the assessment device recorded reaction time. The returned latency evaluation is applied by modification of assessment data with the latency evaluation.

In yet another aspect, a method is configured to address latency variability. Reaction time is tested, including first and second reaction times. The first reaction time is a difference between stimuli presentation on a visual display and receipt of a response to the stimuli. The second reaction time is a recordation difference between the time of the stimuli presentation and the time of receipt of the response to the stimuli by embedded hardware in communication with the stimuli presentation. A latency variability value is calculated and returned from latency of the calculated first and second reaction times. The returned latency is applied, with the application including modifying assessment data with an assessed average latency.

Other features and advantages of this invention will become apparent from the following detailed description of the presently preferred embodiment(s) of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a block diagram illustrating a calibration device in communication with an assessment device.

FIG. 2 depicts a flow chart illustrating a process for testing reaction time that factors in both hardware and software latencies.

FIG. 3 depicts a flow chart illustrating process flow of the functionality of the calibration device as it interfaces with the assessment device.

FIG. 4 is a flow chart illustrating logic of the calibration device during an assessment.

FIG. 5 depicts a block diagram illustrating the calibration device in communication with the assessment device, and specifically, the components that comprise the device and enable the functionality thereof.

FIG. 6 depicts a flow chart illustrating a process for quality control assessment.

FIG. 7 depicts a flow chart illustrating a process for calibrating the calibration device.

FIG. 8 depicts a flow chart illustrating a process for applying the calibration of the assessment device to output of assessment data.

FIG. 9 depicts a flow chart illustrating a process for assessing functionality of the assessment device.

FIG. 10 depicts a block diagram illustrating hardware components for implementing the functionality of the calibration device.

FIG. 11 depicts a block diagram illustrating hardware components of a cloud computing node or implementing the functionality of the calibration device.

FIG. 12 depicts an illustrative example of a cloud computing environment, in accordance with an embodiment.

FIG. 13 depicts an illustrative example of abstraction model layers, in accordance with an embodiment.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

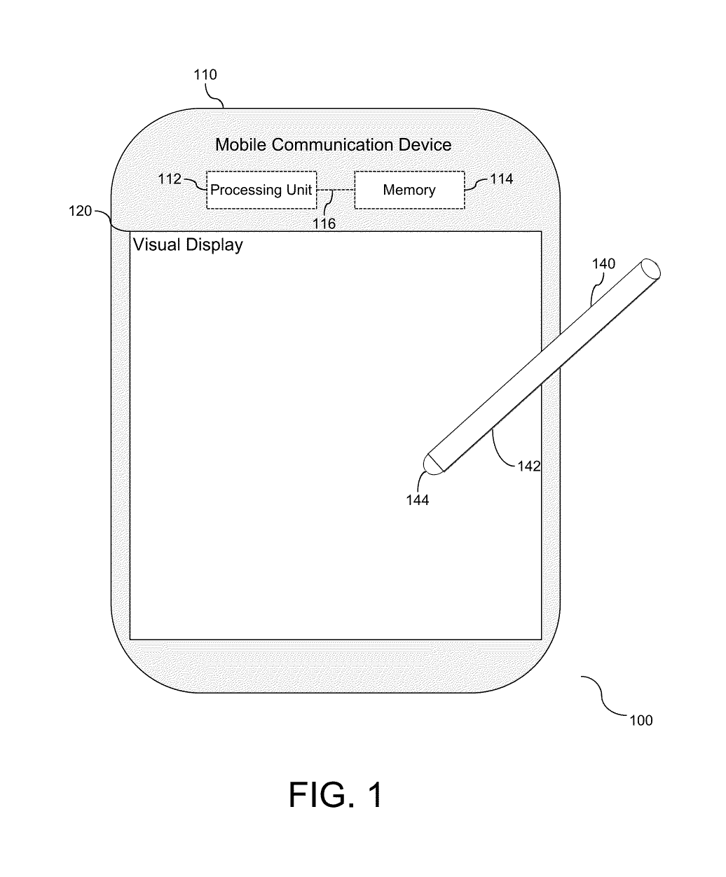

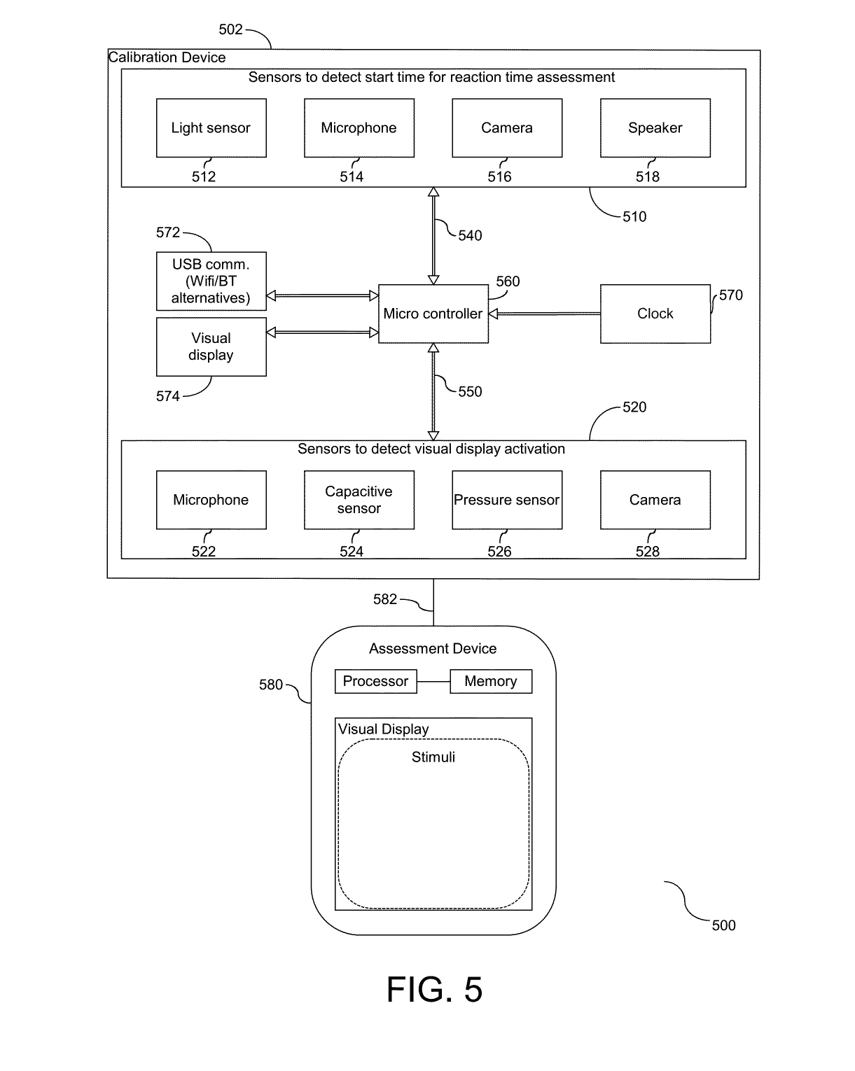

Referring to FIG. 1, a block diagram (100) is provided illustrating a calibration device (140) in communication with a typical assessment device (110), or in one embodiment, a mobile communication apparatus configured as the assessment device. Specifically, the assessment device (110) is shown with a processing unit (112) in communication with memory (116) across a bus (114). A visual display (120) is shown embedded with the assessment device and further in communication with the processor unit (112) and memory (116). The visual display (120) is configured to function as a visual interface for displaying an assessment protocol, and in one embodiment converting the mobile device to an assessment device, at least temporarily. Details of the assessment device are shown and described in the supporting drawing figures. A calibration device (140) is shown in physical proximity to the assessment device (110), and specifically the visual display (120). The hardware of the calibration device is shown and described in detail in FIG. 5. By way of an example, the calibration device (140) is shown here in the form of a stylus with one end (142) having an input device (144) for use on or with the assessment device configured with a capacitance-sensitive visual display, such as visual display (120).

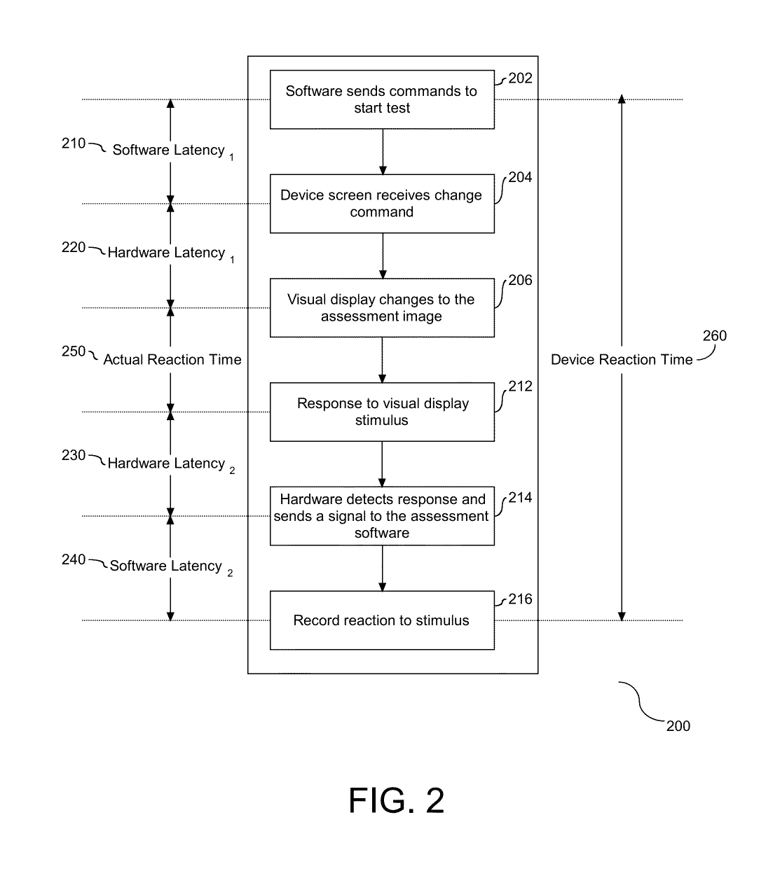

Referring to FIG. 2, a flow chart (200) is provided illustrating a process for testing reaction time that factors in both hardware and software latencies. As shown there are two classes of latencies, hardware latency and software latency, both which may take place and are accounted for in two separate intervals. As shown herein, the flow chart shows first and second software latencies (210) and (240), respectively, and first and second hardware latencies (220) and (230), respectively. Cognitive assessment is conducted through reaction to a visual presentation. The initial software latency (210) is defined as the time difference associated with the software sending a command to start the cognitive assessment (202) and an associated visual display receiving a change command (204). The start time of the assessment at step (202) is recorded. The initial hardware latency (220) is defined as the time difference associated with command change at step (204) and an actual change of the visual display to the assessment stimuli (206). Accordingly, both the initial hardware and software latencies pertain to the start of the cognitive assessment. In one embodiment, cognitive assessment includes showing stimuli on a visual display and assessing the time it takes to respond to the stimuli, which is defined as the user's actual reaction time (250). In one embodiment, the stimuli are presented on the visual display in the form of one or more images.

A second set of hardware and software latencies associated with cognitive assessment are assessed. The second hardware latency (230) is the detection latency associated with detecting human response after or during reaction to presentation. More specifically, the response detection may include touch detection (e.g. pressure and capacitive) latency during reaction to presentation. As shown, the assessment stimuli are projected onto a visual display (206) and a response to the stimuli is indicated (212). In one embodiment, the assessment stimuli are referred to as a screen stimulus. A response to the screen stimulus at step (212) may take place in different forms, touch, text, voice, etc. Regardless of the form of the stimulus response, hardware associated with the visual display detects the response and sends a response signal to the assessment software (214). The second hardware latency (230) is defined as the difference from the response stimulus at step (212) to the detection of the response at step (214), and in one embodiment, the touch screen is integrated into the visual display. Accordingly, the second hardware latency is directly related to the visual display touch screen input, and in one embodiment detection of finger contact on the display.

The second software latency (240) addresses communication of a response to the stimulus to the software. As shown and described above, in response to the hardware detecting a stimulus response, a signal pertaining to the response is communicated to the assessment software. Data associated with the response is acquired and is employed as software test results. More specifically, reaction to the stimulus on the hardware device is recorded together with the time when the reaction took place (216). The difference between sending a signal to the test software and receiving and storing the signal is defined as the second software latency (240).

Based on the multiple hardware and software latency assessments shown in FIG. 2, two separate reaction times may be considered. One reaction time is referred to as the user's actual reaction time (250), and it is defined as the difference between the visual display change at step (206) and indication of a response by a user to the stimulus at step (212). Another reaction time is referred to as a device recorded reaction time (260) and it is defined as the difference between the software recorded start time of sending a communication to start the assessment and the software receiving a signal from the hardware that a response to the stimulus has been received and recorded end time (216). Latency of the assessment device is referred to herein as the device latency, which is defined as the difference between the device recorded reaction time (260) and the actual reaction time (250). The actual reaction time would be the reaction time of an administrator during a calibration or of a user during an assessment.

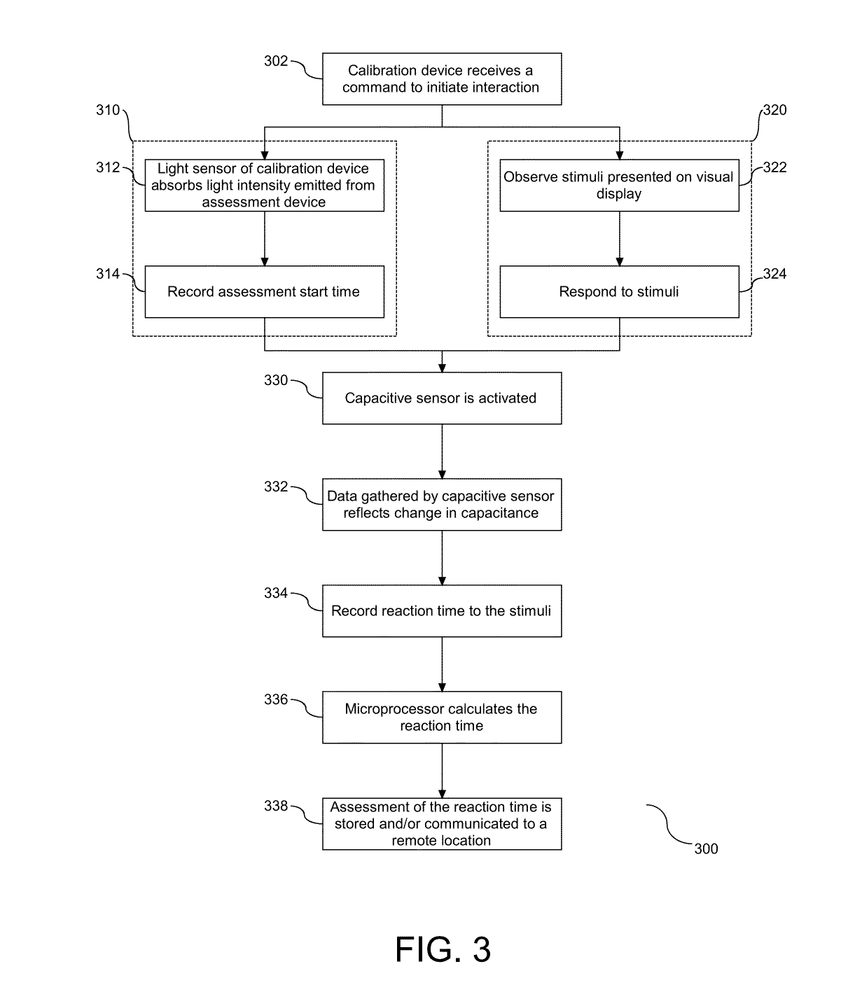

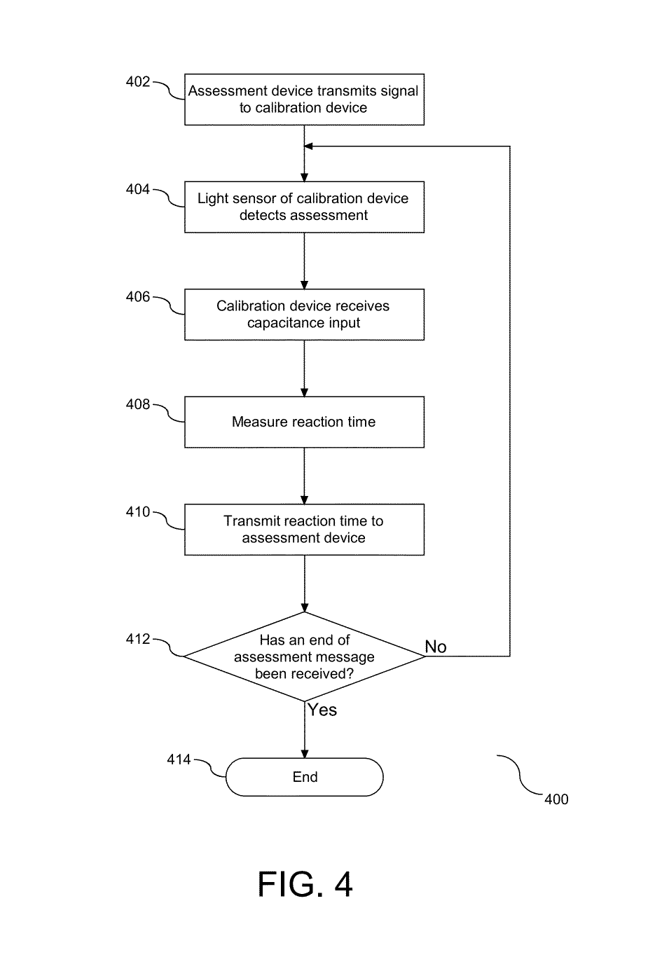

As shown and described herein, there are two primary components employed, including a calibration device with logic flow shown as described in FIG. 4, and an assessment device. Referring to FIG. 3, a flow chart (300) is provided illustrating the process flow of the functionality of the assessment device as it interfaces with the calibration device. The calibration device receives a command from the assessment device to initiate interaction (302). At step (302), the calibration device starts monitoring the assessment device for a reaction time measure. The calibration device is configured with a light sensor and a separate capacitive sensor, or in one embodiment, the light and capacitive sensors are co-located. The light sensor functions by responding to a change in light intensity measurement(s) associated with the assessment device.

The process diverges after the command at step (302), with a first branch (310) addressing the functionality of software and a second branch (320) addressing the functionality of human interaction. More specifically, in the first branch (310), a light sensor of the calibration device absorbs the light intensity emitted from the visual display of the assessment device, and specifically, the change in the emitted intensity (312). The detected change in the light intensity reflects the start of the assessment. As such, the time in which the change is detected at step (312) is recorded at the assessment start time (314). In one embodiment, a microprocessor or an equivalent tool is embedded in the calibration device and functions at step (314) to record or facilitate the recordation of the assessment start time. Accordingly, as shown herein, a light sensor is employed to relate the change in light intensity to the assessment being conducted.

With respect to the second branch, an administrator observes stimuli presented on an associated visual display (322), and physically responds to the stimuli (324) by touching the calibration device to the display screen of the assessment device in a manner similar to how a typical user would interact with the assessment device. In one embodiment, the response is through the input device (144) of the stylus (140). The first and second branches (310) and (320) take place in parallel with the software of the first branch (310) processing the input of the second branch (320).

The calibration device described herein is configured to communicate with the assessment device, and specifically indicia or stimuli presented on an associated visual display. As described above, the calibration device is configured with a light sensor to detect a change in light intensity. In addition, the calibration device is configured with a capacitive sensor, for interaction with the assessment device or in one embodiment, an alternative secondary surface or physical interface, which in one embodiment may include a capacitive screen. In one embodiment, the capacitive sensor has an increased capacitance as the proximity of the sensor to the visual display decreases. Following steps (314) and (324) the capacitive sensor of the calibration device and an associated capacitive sensor of the assessment device are activated (330). In one embodiment, the capacitive sensor of the calibration device models a human finger and movement thereof with respect to the capacitive sensor on the assessment device. Data gathered by the capacitive sensor of the calibration device reflects a change in capacitance (332), and any such detected change is recorded. In one embodiment, a microprocessor or an equivalent tool is embedded in the calibration device and functions at step (332) to record a reaction to the stimuli and an end time to the test (334). The start time of the test is recorded by the change in light intensity at steps (312) and (314), and the end time of the test is recorded by the capacitive sensor, as shown at steps (332) and (334).

In a neuro-cognitive assessment or a neuro-psychological assessment, the duration between the presentation of the stimuli and the reaction to the stimuli is a critical factor. The calibration device functions to record the interval from the presentation to the reaction. The difference between the detection of the presentation of the stimuli and the detection of the pressure is the assessed value of the reaction time. As shown herein, the device memory stores the start time reflected in a change of light intensity and the end time reflected in the change in pressure. The microprocessor calculates the reaction time (336). In one embodiment, the microprocessor communicates the calculated reaction time to the assessment device or to a remote location. Similarly, in one embodiment, the microprocessor, or the equivalent thereof, is remote from the device and the start and end times are merely communicated from the calibration device to a remote microprocessor. Regardless of the location of the microprocessor, the assessment of the reaction time is stored and/or communicated to a remote location and/or displayed on the calibration device (338). Accordingly, as shown herein, the reaction time data is gathered by the assessment device.

The calibration device is provided to interface between the person subject to the cognitive assessment and the assessment device. In one embodiment, the calibration device is referred to as an interface device, and may be, but is not limited to, the form of a stylus. Similarly, in one embodiment, the calibration device is employed by a user. Referring to FIG. 4, a flow chart (400) is provided illustrating the process flow of logic for the calibration device during an assessment. As shown, the assessment device transmits a signal to the calibration device indicating the start of an assessment (402). The calibration device is configured with a light sensor, which detects assessment stimuli, and a user of the calibration device touches the visual display that is rendering the assessment stimuli (404). As such, when the user responds by tapping the screen, the calibration device receives capacitive input (406). The time interval between exhibition of the stimuli at step (404) and reaction to the stimuli by the capacitive input of the calibration device (406) is measured (408). This measurement is referred to as the reaction time, and it is transmitted to the assessment device as reaction time data (410). Following each measurement, it is determined if an end of assessment message has been received (412). An affirmative response to the determination at step (412) concludes the flow logic (414), and a non-affirmative response to the determination at step (412) is following by a return to step (404). Accordingly, the logic flow shown herein demonstrates the use and communication between the calibration device and the assessment device during a user assessment.

Referring to FIG. 5, a block diagram (500) is provided illustrating the calibration device in communication with the assessment device, and specifically, the components that comprise the calibration device and enable the functionality thereof. As shown, the calibration device (502) is configured with two sensors, or in one embodiment, two sets of sensors. For descriptive purposes, each of the sensor classifications will be described as a set of sensors. A first set of sensors (510) are employed and configured to detect start time for reaction time assessment. In one embodiment, the first set (510) includes a light sensor (512), a microphone (514), and a camera (516). A second set of sensors (520) are employed and configured to detect touch screen activation by an external source, i.e. a third party. In one embodiment, the second set (520) includes a microphone (522), a capacitive sensor (524), a pressure sensor (526), and a high speed camera (528). Similarly, in one embodiment, the camera may include a high-speed camera to detect presentation of stimuli and activation of the visual display of the assessment device, the activation including but not limited to, touching of the display. The sensors shown herein are selected to detect the start time of a reaction time test and the stop time of the test. In one embodiment, the sensors shown herein may be substituted or replaced by alternative sensors that support the detection of the start and stop times of the test. As described above, there is a latency associated with use of the assessment device. The latency may be hardware or software specific. In one embodiment, testing an individual assessment device with different sensors may help determine the source of the hardware or software latency.

Each of the first set of sensors (510) and the second set of sensors (520) are separately in communication with a micro-controller (560), as shown as (540) and (550), respectively. In addition, the micro-controller is in communication with a clock (570), communication output (572), such as a USB communication, WiFi, or an alternative communication interface, and visual display (574). In one embodiment, the calibration device may facilitate an accurate method of determining reaction time when the assessment device has failed timing quality control, or to improve timing results. For example, if it is determined that the assessment device has high latency variability in the visual display, the calibration device would be used to calculate reaction time during assessment.

An assessment device (580) is shown in communication with the calibration device (502) at (582). The assessment device is shown with a processing unit (584) in communication with memory (588) across a bus (586). The assessment device is configured with a visual display (590) that is shown herein to exhibit stimuli (592). In one embodiment, the assessment device (580) may be a mobile communication device with the communication link (582) being a wireless communication format with the calibration device (502). Accordingly, the assessment device (580) is configured to exhibit stimuli for an assessment, with the calibration device (502) enabling and supporting communication with the assessment via the hardware shown and described herein.

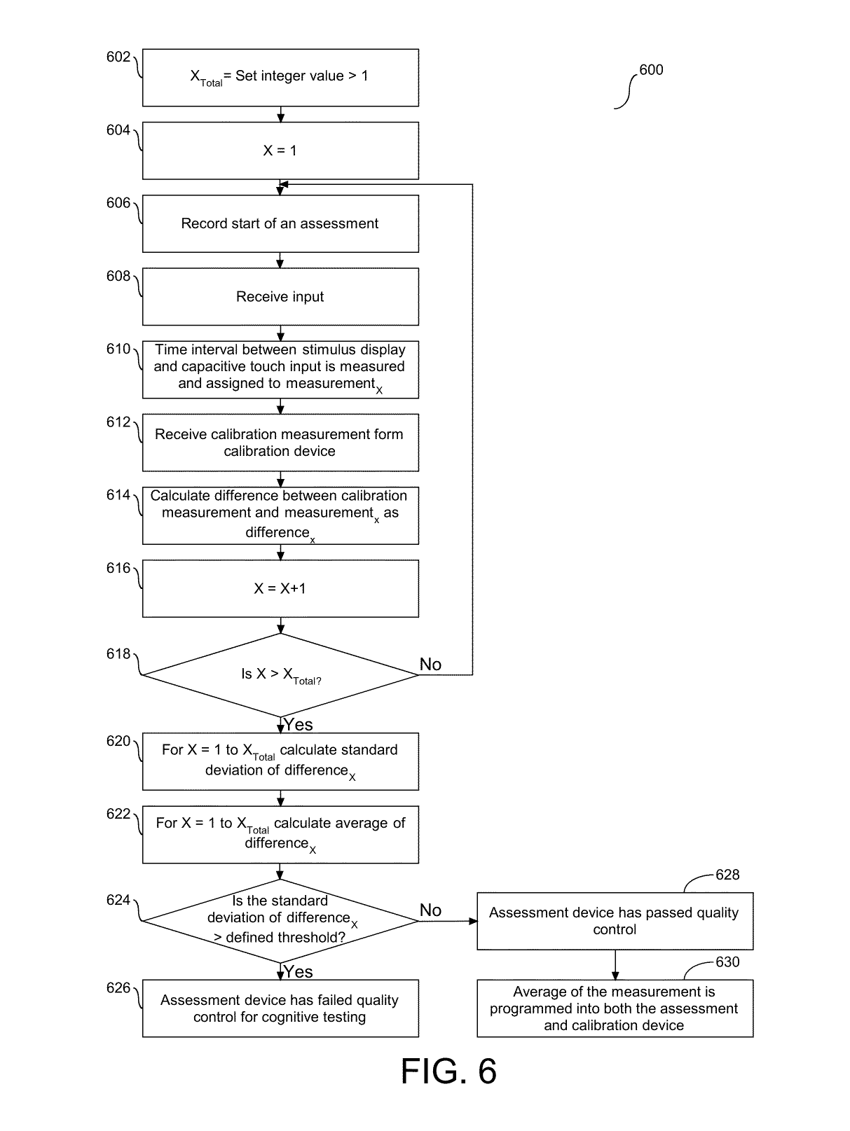

The calibration device may be employed to provide a quality control for the assessment device. Referring to FIG. 6, a flow chart (600) is provided illustrating a process for quality control assessment. As shown, a measurement counting variable is employed. More specifically, the variable X_{Total} the quantity of measurements to be obtained in the quality control assessment. Measurement_{X} is the reaction time value for each X iteration. As an initial step in the process, an integer value identifying the quantity of measurements is set (602). In one embodiment, a default value may be pre-programmed for the assessment, or the value may be manually entered or otherwise adjusted. Following step (602), an associated measurement counting variable is initialized (604), after which the start of an assessment is recorded (606) and then receives input (608), which as described above may come from a capacitive sensor. The time interval between the recording of the start of the assessment at (406), such as the light or change in intensity of the light, until input is received (608). Detection of input, which in one embodiment is capacitive touch, at step (608) is measured as the time interval between stimulus display and capacitive touch, and the measurement is assigned to the measurement variable, measurement_{X}, (610). Following the measurement at step (610), a calibration measurement is received from the calibration device (612), and the difference between the calibration measurement and measurement_{X} takes place and is assigned to the variable difference_{X} (614). Following step (614), the counting variable associated with the quantity of measurements is incremented (616), and it is determined if the maximum quantity of measurements set at step (602) has been reached (618). A negative response to the determination at step (618) is followed by a return to step (606), and a positive response is followed by ascertaining whether the assessment device has passed or failed the quality control evaluation. More specifically, following a positive response to the determination at step (618), a standard deviation is calculated for the assessed differences (620) and an average of the differences is also calculated (622). It is then determined if the calculated standard deviation is greater than a threshold value (624), where the threshold value is a maximum variability of the timing as reported by the assessment device. A positive response to the determination at step (624) is an indication that the assessment device has failed quality control for the cognitive testing because it is imprecise and cannot precisely test reaction time (626). In one embodiment, the assessment device can be inaccurate, but if it is imprecise it is not useable. In contrast, a negative response to the determination at step (620) is an indication that the assessment device has passed quality control (628) and the average of the measurements is programmed into both the assessment and calibration devices (430). Accordingly, as shown herein the assessment device may be processed through quality control.

Quality control may be based on one assessment or multiple assessments. In one embodiment, hardware and/or software latency may be assessed over the course of multiple assessments, and a compilation of the assessments may be processed through quality control. Similarly, in one embodiment, an average of the latencies may be compiled for quality control assessment. In one embodiment, the operating system update forces a test of the assessment device as a precursor for activation. The assessment device may fail for a variety of reasons. For example, in one embodiment, too many applications may be processing on the device. Such applications would need to be closed and the assessment device would need to be processed through quality control prior to activation. Other failures include, but are not limited to, communication failure, and a standard deviation of latency being greater than a threshold. Accordingly, as shown herein, an assessment device that fails quality control is disabled from future assessment testing via cloud or server authentication.

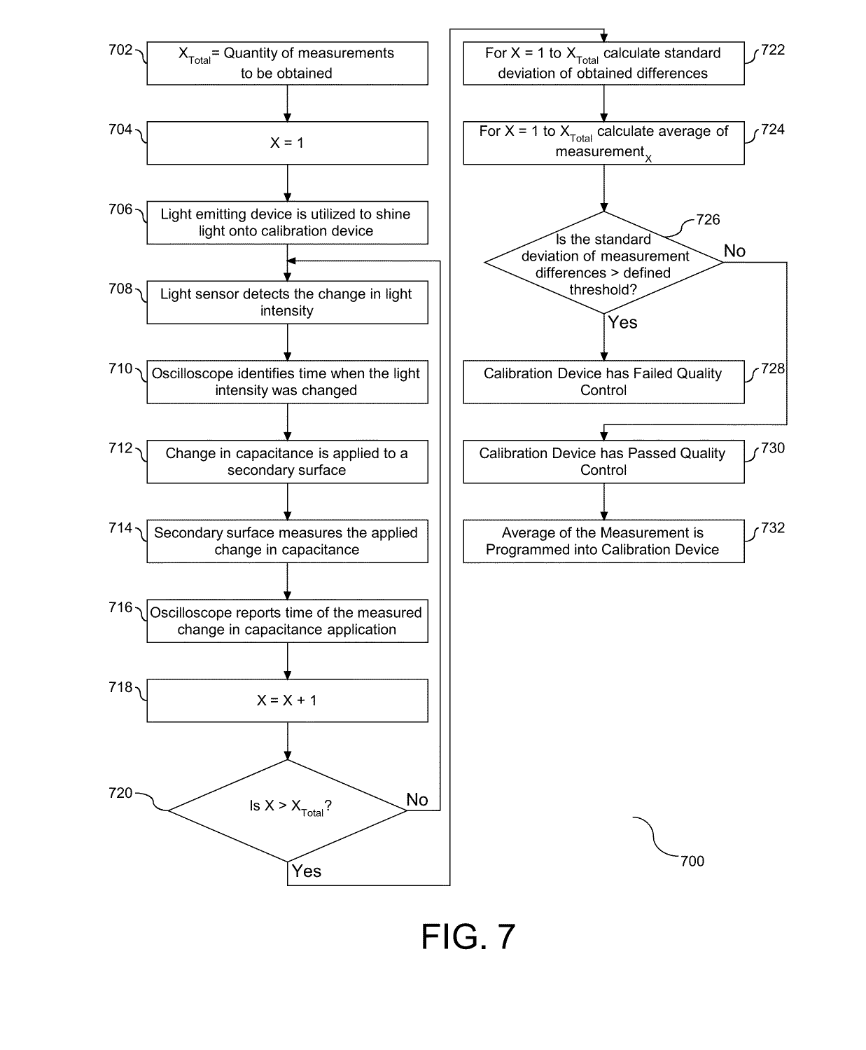

Before the calibration device is employed with the assessment, the calibration device may itself be tested and calibrated. Referring to FIG. 7, a flow chart (700) is provided illustrating a process for calibrating the calibration device. As shown, a measurement counting variable is employed. More specifically, the variable X_{Total} represents the quantity of measurements to be obtained in the quality control assessment. As an initial step in the process, an integer value identifying the quantity of measurements is set (702). In one embodiment, a default value may be pre-programmed for the assessment, or the value may be manually entered or otherwise adjusted. Following step (702) and prior to calibration, a counting variable X is initialized (704). As shown, a light emitting device is utilized to shine light onto the calibration device (706). A light sensor embedded within the calibration device, or otherwise in communication with the calibration device, detects the change in light intensity (708), and an oscilloscope identifies the time when the light intensity was changed (710). In response to the detection at step (708), the calibration device applies pressure or a change in capacitance to a secondary surface in communication with the oscilloscope (712). In one embodiment, a capacitive sensor embedded within or otherwise connected to the device detects the change in capacitance. The secondary surface includes an associated sensor to measure the applied pressure or change in capacitance (714), and the oscilloscope reports the time of the measured change in capacitance (716).

The assessment shown in FIG. 7, namely steps (708)-(716) are repeated for calibration of the calibration device. Namely, following step (716), the counting variable X is incremented (718), and it is determined if the maximum quantity of measurements set at step (702) has been reached (720). A negative response to the determination at step (720) is followed by a return to step (708), and a positive response is followed by ascertaining whether the calibration device has passed or failed the quality control evaluation. More specifically, following a positive response to the determination at step (720), a standard deviation is calculated for all of the obtained differences in the two sets of measurements (722) and an average of the measurements is also calculated (724). It is then determined if the calculated standard deviation of the differences of the two sets of reaction time measurements is greater than a threshold value (726), where the threshold value is a maximum variability of the timing as allowed for the calibration device. A positive response to the determination at step (726) is an indication that the calibration device has failed quality control for the assessment because it cannot precisely test reaction time (728). In contrast, a negative response to the determination at step (726) is an indication that the calibration device has passed quality control (730) and the average of the measurements as calculated at step (724) is programmed into the calibration device (732).

The process shown in FIG. 7 is one aspect of calibration of the calibration device. In one embodiment, the calibration process may be embedded within the calibration device, and a protocol may be established so that prior to use of the calibration device for actual testing, the calibration device must be processed through the calibration algorithm. For example, in one embodiment, circuitry and sensors may be embodied with the calibration device and or the assessment tool for calibration. Similarly, performance of the calibration device may be affected by environmental factors. For example, changes in temperature or humidity may affect performance. In one embodiment, the calibration device may detect such changes, or a detection of environmental changes may be communicated to the calibration device, for example from an external sensor, and in either scenario the detected or communicated change would require calibration, as shown and described in FIG. 7.

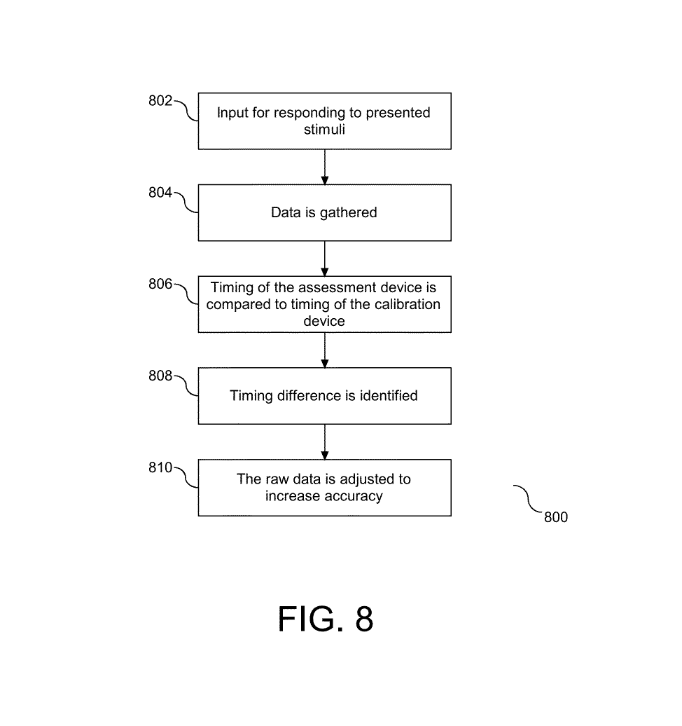

Referring to FIG. 8, a flow chart (800) is provided illustrating a process for applying an adjustment value of the calibration device to increase accuracy of the assessment data output. As shown, the calibration device is employed to communicate with the assessment device, and specifically as an input for responding to presented stimuli (802). When an assessment is completed, the data is gathered (804). Timing of the assessment device is then compared to timing of the calibration device (806), and a timing difference is identified and stored local to the assessment device (808), as calibration data. In one embodiment, the identified timing difference may also be stored local to the calibration device. The results of the assessment are referred to herein as raw data. The raw data is adjusted to increase accuracy (810) by employing the timing comparison identified at step (808). The adjustment at step (810) enables the software to improve accuracy of the test results, i.e. accuracy for determining impairment, such as an impairment associated with a user in communication with the assessment device, with the impairment including, but not limited to, neurobehavioral and cognitive impairment. All subsequent assessments done with the assessment device can use calibration data to adjust the raw data without the need for the calibration device until a software configuration change occurs on the assessment device.

The calibration shown and described herein pertains to light and capacitive sensors. As shown in FIG. 5, additional or alternative sensors may be provided, including a high speed camera. In one embodiment, the calibration device may employ a high speed camera to measure time between light emission and surface contact. In another embodiment a microphone and a speaker may be employed to test latencies. The calibration device and the assessment device may receive audio signals and calibrate based on comparison of audio signal(s) transmitted and detected. Similarly, in one embodiment, radio frequency communication protocol, such as Bluetooth, may be employed as a basis for transmission and comparison. Regardless of the format of the sensors, the sensors are employed with different I/O in communication with the assessment device to find the source of any latency and to quantify the latencies for calibration of the assessment device.

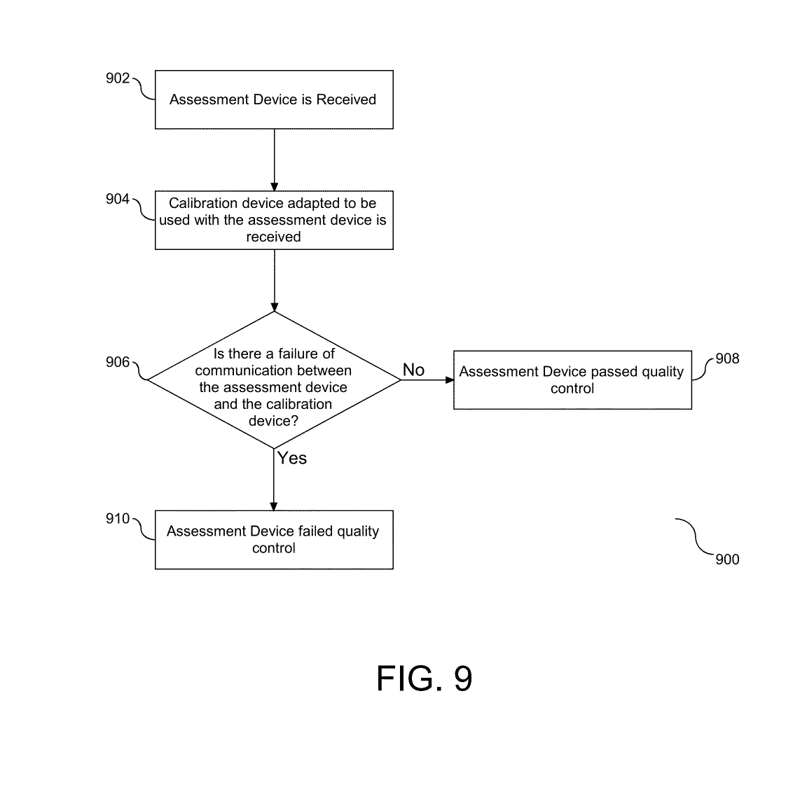

In one embodiment, the assessment device and the calibration device may be two separate components that may be employed to function together for cognitive assessment in order to improve precision and accuracy of reaction time data. Referring to FIG. 9, a flow chart (900) is provided illustrating a process for assessing the functionality of the assessment device. As shown, the assessment device is received (902). Thereafter, a calibration device adapted to be used with the assessment device is received (904). Prior to use of the assessment device, it is determined if there is a failure of communication between the assessment device and the calibration device (906). A negative response to the determination at step (906) is an indication that there is no defect associated with the communication, and the assessment device is validated (908). Conversely, a positive response to the determination at step (906) is an indication that there is a defect associated with the assessment device, and as such, the assessment device is disabled (910) via cloud based resource or server authentication. In one embodiment, the assessment device is configured with software to report or otherwise communicate latency variability of the assessment device to the cloud based resource or remote server, which in return would authenticate or disable the assessment device based on the quality control assessment. Similarly, in one embodiment, the assessment device and the calibration device may communicate locally for latency variability, and in the event of failure of the quality control assessment, the assessment device would self-disable. The local failure and disablement may be communicated to the cloud based resource or remote server at a later point in time. In one embodiment, the latency variability causes the software testing configuration of the assessment device to change or otherwise be modified, including de-authorization of the assessment device, e.g. disable the assessment device, require continued use of the calibration device, or adjust test settings within the assessment device. With respect to continued use of the calibration device, the calibration device would be required and would provide reaction time for every assessment. Based on the latency variability, changes of assessment software configuration may take place to continue measurement of reaction time even with a failure of quality control of the assessment device. For example, a latency high variability may require an increase of trial iterations within an assessment, and low latency variability may decrease trial iterations within an assessment. Defects may be present in the assessment device or the calibration device. As shown in FIG. 9, quality control is employed to assess defects associated with the assessment device.

In one embodiment, the calibration device functions as both an input and a measurement device for assessment and data associated with the assessment is stored within the calibration device. For example, the reaction timing data associated with light intensity and capacitive changes are gathered and stored by the calibration device and transmitted to the assessment device and stored in the assessment device replacing the assessment device's stored reaction time data. The quality control assessment shown in FIG. 9 may be extrapolated to limit functioning of the assessment device to require interaction with the calibration device being tested. For example, in one embodiment, the quality control at step (906) may limit functioning of the assessment device to require interface with the calibration device being tested. Furthermore, the data from the assessment is gathered by the calibration device, and in one embodiment, the data is communicated to the assessment device or related software and stored in memory, such as a persistent storage hardware device. A negative response to the determination at step (906) is an indication that there is no defect associated with the communication, and the assessment device is validated (908). Conversely, a positive response to the determination at step (906) is an indication that there is a defect associated with the assessment device, and as such, the assessment device is not ready for use (910). For example, the communication failure may be due to an improper network setting. Accordingly, as shown herein, an assessment device is processed through quality control to ascertain if the device is ready for use.

The device described above in FIG. 5 has been labeled with tools in the form of sensors and a microcontroller. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

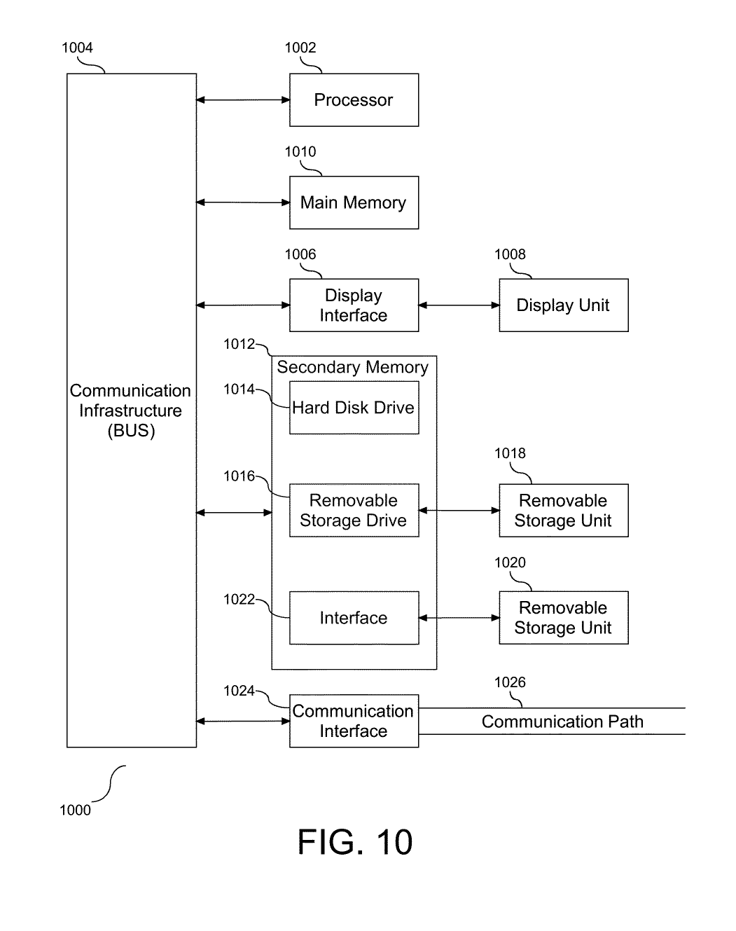

Referring now to the block diagram of FIG. 10, additional details are now described with respect to implementing an embodiment of the present invention. In one embodiment, a computing system is embedded in the actuation device. The computer system includes one or more processors, such as a processor (1002). The processor (1002) is connected to a communication infrastructure (1004) (e.g., a communications bus, cross-over bar, or network).

The computer system can include a display interface (1006) that forwards graphics, text, and other data from the communication infrastructure (1004) (or from a frame buffer not shown) for display on a display unit (1008). The computer system also includes a main memory (1010), preferably random access memory (RAM), and may also include a secondary memory (1012). The secondary memory (1012) may include, for example, a hard disk drive (1014) and/or a removable storage drive (1016). The removable storage drive (1016) reads from and/or writes to a removable storage unit (1018) in a manner well known to those having ordinary skill in the art. Removable storage unit (1018) represents, for example, a magnetic tape, or an optical disk, etc., which is read by and written to by removable storage drive (1016).

In alternative embodiments, the secondary memory (1012) may include other similar means for allowing computer programs or other instructions to be loaded into the computer system. Such means may include, for example, a removable storage unit (1020) and an interface (1022). Examples of such means may include a program package and package interface (such as that found in video game devices), a removable memory chip (such as an EPROM, or PROM) and associated socket, and other removable storage units (1020) and interfaces (1022) which allow software and data to be transferred from the removable storage unit (1020) to the computer system.

The computer system may also include a communications interface (1024). Communications interface (1024) allows software and data to be transferred between the computer system and external devices. Examples of communications interface (1024) may include a modem, a network interface (such as an Ethernet card), a communications port, or a PCMCIA slot and card, etc. Software and data transferred via communications interface (1024) is in the form of signals which may be, for example, electronic, electromagnetic, optical, or other signals capable of being received by communications interface (1024). These signals are provided to communications interface (1024) via a communications path (i.e., channel) (1026). This communications path (1026) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1010) and secondary memory (1012), removable storage drive (1016), and a hard disk installed in hard disk drive (1014).

Computer programs (also called computer control logic) are stored in main memory (1010) and/or secondary memory (1012). Computer programs may also be received via a communication interface (1024). Such computer programs, when run, enable the computer system to perform the features of the present invention as discussed herein. In particular, the computer programs, when run, enable the processor (1002) to perform the features of the computer system. Accordingly, such computer programs represent controllers of the computer system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As shown and described in FIG. 9, quality control may be support with cloud based resources. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Quality control of the assessment device, as shown and described in FIGS. 1-9 may be utilized to leverage the functionality of the cloud model to support the assessments and associated functionality, data storage, etc. Specifically, the assessment device may be configured with a communication platform that supports communication between the assessment device and externally available shared resources, e.g. cloud supported products and services, also referred to herein as a cloud model. Additionally, the calibration device may be configured for direct cloud communications. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

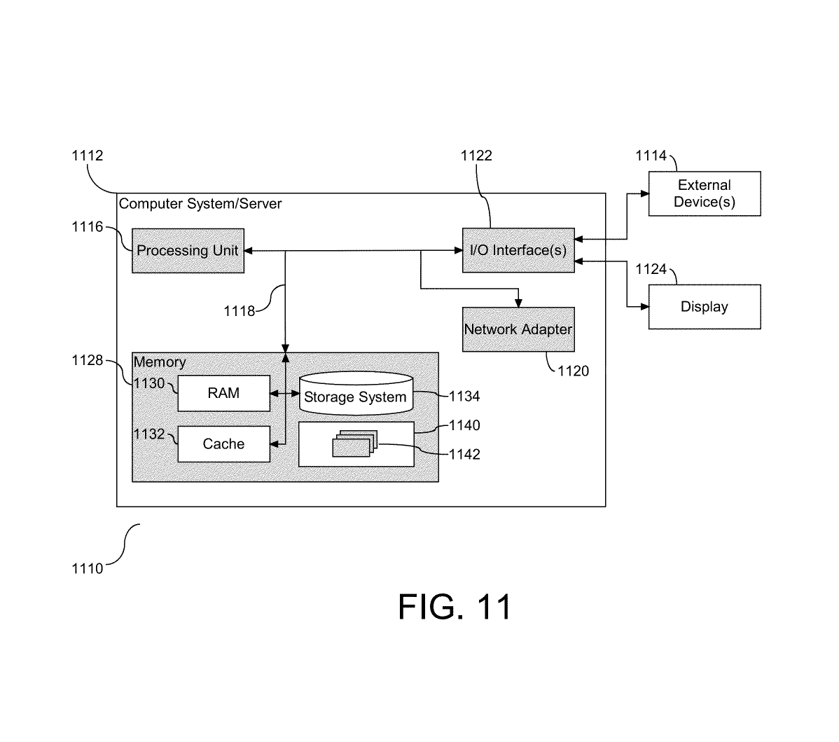

Referring now to FIG. 11, a schematic of a system (1100) is provided. In one embodiment, system (1100) is a cloud computing node. The cloud computing node is only one example of a suitable cloud computing node and is not intended to suggest any limitation as to the scope of use or functionality of embodiments of the invention described herein. Regardless, the cloud computing node is capable of being implemented and/or performing any of the functionality set forth hereinabove.

In the cloud computing node is a computer system/server (1112), which is operational with numerous other general purpose or special purpose computing system environments or configurations. Examples of well-known computing systems, environments, and/or configurations that may be suitable for use with computer system/server (1112) include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (1112) may be described in the general context of computer system executable instructions, such as program modules, being executed by a computer system. Generally, program modules may include routines, programs, objects, components, logic, data structures, and so on that perform particular tasks or implement particular abstract data types. Computer system/server (1112) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server (1112) is shown in the form of a general-purpose computing device. The components of computer system/server (1112) may include, but are not limited to, one or more processors or processing units (1116), a system memory (1128), and a bus (1118) that couples various system components, including system memory (1128) to processor (1116).

Bus (1118) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server (1112) typically includes a variety of computer system readable media. Such media may be any available media that is accessible by computer system/server (1112), and it includes both volatile and non-volatile media, removable and non-removable media.

System memory (1128) can include computer system readable media in the form of volatile memory, such as random access memory (RAM) (1130) and/or cache memory (1132). Computer system/server (1112) may further include other removable/non-removable, volatile/non-volatile computer system storage media. By way of example only, storage system (1134) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (1118) by one or more data media interfaces. As will be further depicted and described below, memory (1128) may include at least one program product having a set (e.g., at least one) of program modules that are configured to carry out the functions of embodiments of the invention.

Program/utility (1140), having a set (at least one) of program modules (1142), may be stored in memory (1128) by way of example, and not limitation, as well as an operating system, one or more application programs, other program modules, and program data. Each of the operating system, one or more application programs, other program modules, and program data or some combination thereof, may include an implementation of a networking environment. Program modules (1142) generally carry out the functions and/or methodologies of embodiments of the invention as described herein.

Computer system/server (1112) may also communicate with one or more external devices (1114) such as a keyboard, a pointing device, a display (1124), etc.; one or more devices that enable a user to interact with computer system/server (1112); and/or any devices (e.g., network card, modem, etc.) that enable computer system/server (1112) to communicate with one or more other computing devices. Such communication can occur via Input/Output (I/O) interfaces (1122). Still yet, computer system/server (1112) can communicate with one or more networks such as a local area network (LAN), a general wide area network (WAN), and/or a public network (e.g., the Internet) via network adapter (1120). As depicted, network adapter (1120) communicates with the other components of computer system/server (1112) via bus (1118). It should be understood that although not shown, other hardware and/or software components could be used in conjunction with computer system/server (1112). Examples, include, but are not limited to: microcode, device drivers, redundant processing units, external disk drive arrays, RAID systems, tape drives, and data archival storage systems, etc.

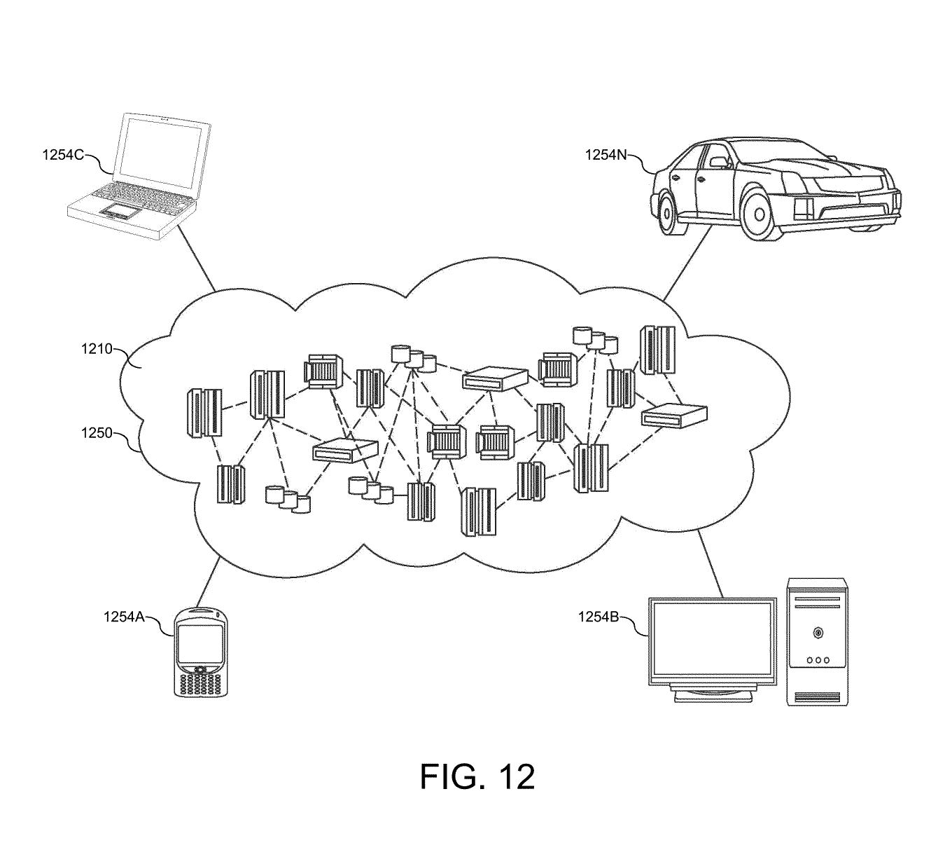

Referring now to FIG. 12, an illustrative cloud computing environment (1200) is depicted. As shown, cloud computing environment (1200) comprises one or more cloud computing nodes (1210) with which local computing devices used by cloud consumers, such as, for example, personal digital assistant (PDA) or cellular telephone (1254A), desktop computer (1254B), laptop computer (1254C), and/or automobile computer system (1254N) may communicate. Nodes (1210) may communicate with one another. They may be grouped (not shown) physically or virtually, in one or more networks, such as Private, Community, Public, or Hybrid clouds as described hereinabove, or a combination thereof. This allows cloud computing environment (1200) to offer infrastructure, platforms and/or software as services for which a cloud consumer does not need to maintain resources on a local computing device. It is understood that the types of computing devices (1254A)-(1254N) shown in FIG. 12 are intended to be illustrative only and that computing nodes (1210) and cloud computing environment (1200) can communicate with any type of computerized device over any type of network and/or network addressable connection (e.g., using a web browser).

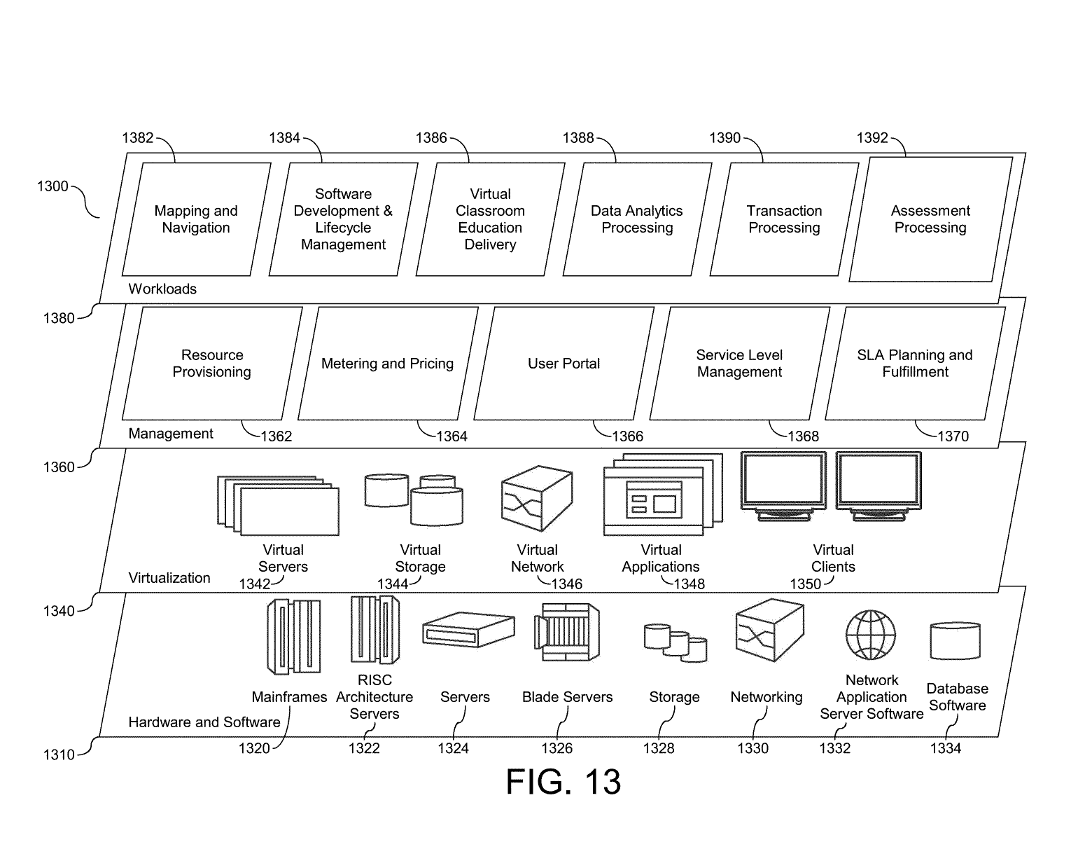

Referring now to FIG. 12, a set of functional abstraction layers (1200) provided by cloud computing environment (1200) of FIG. 12 is shown. It should be understood in advance that the components, layers, and functions shown in FIG. 13 are intended to be illustrative only and embodiments of the invention are not limited thereto. As depicted, the following layers and corresponding functions are provided:

Hardware and software layer (1310) includes hardware and software components. Examples of hardware components include mainframes (1320); RISC (Reduced Instruction Set Computer) architecture based servers (1322); servers (1324); blade servers (1326); storage devices (1328); networks and networking components (1330). In some embodiments, software components include network application server software (1332) and database software (1334).

Virtualization layer (1340) provides an abstraction layer from which the following examples of virtual entities may be provided: virtual servers (1342); virtual storage (1344); virtual networks (1346), including virtual private networks; virtual applications and operating systems (1348); and virtual clients (1350).

In one example, management layer (1360) may provide the functions described below. Resource provisioning (1362) provides dynamic procurement of computing resources and other resources that are utilized to perform tasks within the cloud computing environment. Metering and Pricing (1364) provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal (1366) provides access to the cloud computing environment for consumers and system administrators. Service level management (1368) provides cloud computing resource allocation and management such that required service levels are met. Service Level Agreement (SLA) planning and fulfillment (1370) provides pre-arrangement for, and procurement of, cloud computing resources for which a future requirement is anticipated in accordance with an SLA.

Workloads layer (1380) provides examples of functionality for which the cloud computing environment may be utilized. Examples of workloads and functions which may be provided from this layer include: mapping and navigation (1382); software development and lifecycle management (1384); virtual classroom education delivery (1386); data analytics processing (1388); transaction processing (1390); and assessment processing of one or more aspects of the present invention (1392).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the implementation of detecting and accommodating latency with respect to interfacing between the assessment and calibration devices ensures that data generated from the assessment is precisely determined.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

What is claimed is:

1. A method comprising:
testing reaction time between a calibration device and an assessment device, including configuring the assessment device with stimuli, and configuring the calibration device to measure stimuli;
calculating reaction time as a difference between stimuli presenting on a visual display and receipt of a response to the stimuli;
calculating calibration device recorded reaction time as a difference between the time of the stimuli presentation and the time of receipt of the response to the stimuli by embedded hardware of the assessment device;
returning a latency evaluation of the assessment device as a difference between the calibration device recorded reaction time and the assessment device reaction time; and
applying the returned latency evaluation, including modifying assessment data with the latency evaluation.

2. The method of claim 1, further comprising configuring the calibration device with a light sensor to detect a change in light intensity emitted from a visual display associated with the assessment device.

3. The method of claim 2, further comprising configuring the calibration device with a capacitive sensor to detect a change in capacitance associated with a response to the stimuli of the assessment device.

4. The method of claim 3, further comprising recording data associated with the light sensor and capacitive sensor, and communicating the recorded data to the assessment device.

5. The method of claim 1, further comprising measuring a calibration device latency variability for quality control, including measuring the light sensor for responding to light stimuli.

6. The method of claim 5, further comprising measuring an assessment device latency variability for quality control, including measuring the light sensor for responding to light stimuli.

7. The method of claim 6, further comprising using a capacitive sensor to record response to stimuli.

8. The method of claim 6, further comprising disabling the assessment device in response to latency variability of the assessment device.

9. The method of claim 6, further comprising disabling the assessment device in response to communication failure between the assessment device and the calibration device.

10. The method of claim 6, further comprising disabling the assessment device in response to failed quality control of the visual display of the assessment device.

11. The method of claim 6, further comprising disabling the assessment device from a remote apparatus, the apparatus selected from the group consisting of: a cloud based resource and a remote server.

12. The method of claim 6, further comprising locally disabling the assessment device in response to a failed quality control assessment, and communicating the disabled device to a remote apparatus selected from the group consisting of: a cloud based resource and a remote server.

13. The method of claim 6, further comprising requiring continued use of the calibration device to measure the reaction time in response to a failed quality control of the assessment device.

14. The method of claim 6, further comprising re-configuring the assessment device responsive to latency variability, wherein high latency variability increases iterations within an assessment and low latency variability decreases iterations within the assessment.

15. The method of claim 1, further comprising replacing a failed device, the device selected from the group consisting of: the assessment device and the calibration device.

16. The method of claim 1, further comprising a high speed camera for detecting presentation of stimuli and activation of the visual display of the assessment device.

17. A system comprising:
a calibration device in communication with an assessment device, the assessment device configured to display stimuli, and the calibration device configured to measure the displayed stimuli;
the assessment device to calculate user reaction time as a difference between presentation of the display stimuli and receipt of a response to the displayed stimuli;
the calibration device to calculate recorded reaction time as a difference between the time of stimuli display and time receipt of the response to the display stimuli by embedded hardware of the assessment device;
a reaction time assessment between the calibration device and the assessment device, the assessment to return a latency evaluation of the assessment device as a difference between the calibration device recorded reaction time and the assessment device recorded reaction time; and
application of the returned latency evaluation, including modification of assessment data with the latency evaluation.

18. The system of claim 17, further comprising the calibration device having a light sensor to detect a change in light intensity emitted from a visual display associated with the assessment device.

19. The system of claim 18, further comprising the calibration device having a capacitive sensor to detect a change in capacitance associated with a response to the stimuli of the assessment device.

20. The system of claim 19, further comprising the calibration device to record data associated with the light sensor and capacitive sensor, and to communicate the recorded data to the assessment device.

21. The system of claim 17, further comprising the calibration device to measure latency variability for quality control, including measurement of the light sensor for responding to light stimuli.

22. The system of claim 21, further comprising the calibration device to measure the capacitive sensor for responding to change in capacitance.

23. The system of claim 21, further comprising the calibration device to disable the assessment device in response to a failed quality control of the calibration device or the assessment device.

24. The method of claim 23, further comprising the assessment device disabled from a remote apparatus, the apparatus selected from the group consisting of: a cloud based resource and a remote server.

25. The method of claim 23, further comprising the assessment device locally disabled in response to a failed quality control assessment, and communication of the disabled device to a remote apparatus selected from the group consisting of: a cloud based resource and a remote server.

26. The system of claim 17, further comprising replacement of a failed device, the device selected from the group consisting of: the assessment device and the calibration device.

27. The system of claim 17, further comprising a high speed camera to detect presentation of stimuli and activation of the visual display of the assessment device.

28. A method comprising:
testing reaction time, including configuring a calibration device to measure stimuli;
calculating a first reaction time as a first difference between stimuli presentation on a visual display and receipt of a response to the stimuli;
calculating a second reaction time as a recordation difference between the time of the stimuli presentation and the time of receipt of the response to the stimuli by embedded hardware in communication with the stimuli presentation;
returning a latency variability value as calculated from latency of the calculated first and second reaction times; and
applying the returned latency variability value, including modifying assessment data with an assessed average latency.
